(19) United States
(12) Patent Application Publication
(10) Pub. No.: US 2009/0313010 A1
(43) Pub. Date: Dec. 17, 2009

(54) AUTOMATIC PLAYBACK OF A SPEECH SEGMENT FOR MEDIA DEVICES CAPABLE OF PAUSING A MEDIA STREAM IN RESPONSE TO ENVIRONMENTAL CUES

(75) Inventors: Erik J. Burckart, Raleigh, NC (US); Steve R. Campbell, Lillington, NC (US); Andrew J. Ivory, Wake Forest, NC (US); Mark E. Peters, Chapel Hill, NC (US); Aaron K. Shook, Raleigh, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/137,270

(22) Filed: Jun. 11, 2008

(51) Int. Cl. G10L 21/02; G10L 21/00

(52) U.S. Cl. 704/227; 704/201; 704/E21.001; 704/E21.002

(57) ABSTRACT

A multimedia device can be used to play audio. Speech in an environment proximate to a multimedia device can be detected. The detected speech can be recorded. The playing of the audio can be paused. The recorded speech can be audibly presented. A condition to resume the paused audio can be detected. The paused audio can be resumed from the previously paused position.

### CROSS-REFERENCE TO RELATED APPLICATIONS

U.S. patent application Ser. No. 11/945,732 entitled “AUTOMATED PLAYBACK CONTROL FOR AUDIO DEVICES USING ENVIRONMENTAL CUES AS INDICATORS FOR AUTOMATICALLY PAUSING AUDIO PLAYBACK” are assigned to the same assignee hereof, International Business Machines Corporation of Armonk, N.Y., and contain subject matter related, in a certain respect to the subject matter of the present application. The above-identified patent application is incorporated by reference in its entirety.

### BACKGROUND OF THE INVENTION

The present invention relates to the field of multimedia devices and, more particularly, to automatic playback of a speech segment for media devices capable of pausing a media stream in response to environmental cues.

Portable multimedia devices have become almost ubiquitous resulting in their usage permeating many parts of everyday life. As such, users of portable multimedia devices (e.g., MP3 players) frequently enter and exit conversations while using these devices. Commonly, a user's attention is directed towards the media playback and not on the external environment around the user. For example, a user listening to music can be unaware of another person attempting to start a conversation. In many instances, a person near the user has started a conversation with the user by greeting the user (e.g., “hello”) or even asking a question such as “How are you?” or “What time is it?”. When the user realizes another person initiating a conversation the user has already missed some of the conversation. The user must ask the person initiating the conversation to repeat previously stated remarks. This is a less than ideal solution as many people dislike repeating themselves and can grow quickly annoyed at constantly having to reiterate comments. Since many multimedia devices are manufactured with a multitude of capabilities, it is possible to utilize unrealized functionality to solve the present problem.

### BRIEF DESCRIPTION OF THE SEVERAL VIEWS OF THE DRAWINGS

FIG. 1 is a schematic diagram illustrating a scenario for recording a detected speech segment from environmental cues and presenting the speech to a user in response to a pausing event in accordance with an embodiment of the inventive arrangements disclosed herein.

FIG. 2 is a schematic diagram illustrating a system for automatic playback of a speech segment for media devices capable of pausing a media stream in response to environmental cues in accordance with an embodiment of the inventive arrangements disclosed herein.

FIG. 3 is a flowchart illustrating a method for automatic playback of a speech segment for media devices capable of pausing a media stream in response to environmental cues in accordance with an embodiment of the inventive arrangements disclosed herein.

### DETAILED DESCRIPTION OF THE INVENTION

The present invention discloses a solution for automatic playback of a speech segment for media devices capable of pausing a media stream in response to environmental cues. In the solution, a media device can detect speech proximate to a media device user. The speech can be recorded upon detection and played when the user triggers a pausing event on the media device. The media device can include a multimedia device capable of automatically pausing media playback in response to environmental cues. When a pausing event occurs on the media device, recorded speech playback can begin.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

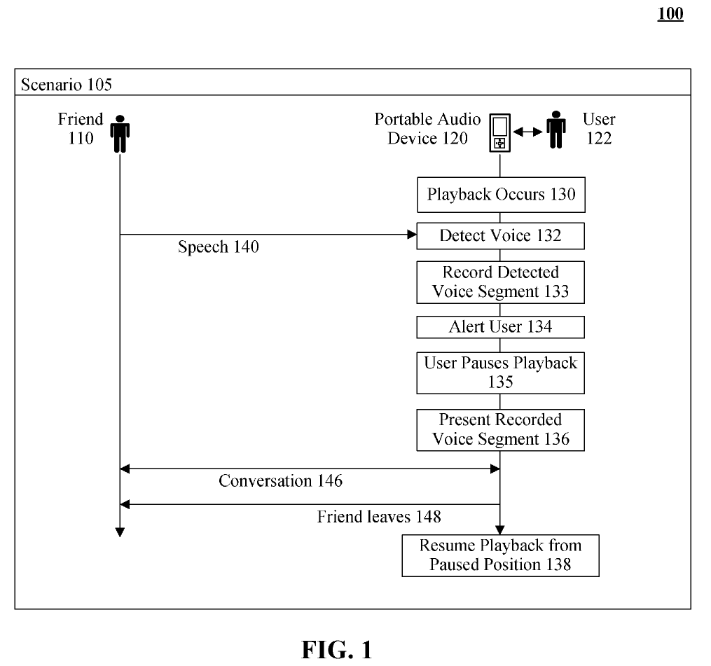

FIG. 1 is a schematic diagram illustrating a scenario 105 for recording a detected speech segment from environmental cues and presenting the speech to a user in response to a pausing event in accordance with an embodiment of the inventive arrangements disclosed herein. In scenario 105, a user 122 utilizing a portable audio device 120, which is producing playback 130. During this time, a friend 110 can speak 140 to user 122. The speech 140 can be detected 132, recorded 133, and presented 136 to user 122 after the device 120 playback is paused 135. This enables user 122 to engage in a conversation 146 with the friend 110 without asking friend 110 to repeat the speech 140, which would otherwise (in absence of presentation 136) be obscured by device 120 presented audio (playback 130).

More specifically, user 122 listening to audio 130 being generated by device 120 can be approached by friend 110. Friend 110 in proximate distance to user 122 can speak (speech 140) to the user 122. Speech 140 can be detected by audio device 120, as noted by the detect voice 132 event. In event 132, voice detection can be configured to be responsive to a decibel threshold as well as other factors. For example, a proximity of a speech source 140 to user 122 can be determined based upon proximity sensors, a direction of the speech 140 can be determined based upon acoustic reflections in the audio environment of device 120, etc. When the voice detection event 132 occurs, a record function of device 120 can be automatically triggered. This function can record the detected voice segment 133 to a storage medium of device 120. The recording 133 of the voice can continue until the playback 130 has paused. Optionally, the recording 133 can also be extended until a pause in the speech 140 occurs to ensure an intelligent amount of the speech 140 is presented 136.

For example, when a voice is detected above a previously established threshold (e.g., sixty decibels), event 132 can fire, which results in the recording 133 of the speech 140. Any speech detection technology can be used herein, such as the detection technologies commonly implemented in dictation devices and/or audio surveillance devices.

The voice detection event 132 can also trigger an event designed to alter user 134 of a communication attempt. For example, the alert 134 can cause a characteristic audio tone to be presented to user 122. In step 135, the user 122 can elect to pause playback of the device 120. Any number of user 122 gestures/motions can be used to pause playback 135, such as a user 122 nodding or shaking their head in a device 120 detectable manner associated with a pausing event. Should user 122 elect to ignore the speech 140 attempt, the playback 130 can continue and the recording 133 can be optionally halted and discarded. Contemplated variations of voice detections (132), alerting 134, and pausing (135) are elaborated upon in cross-referenced U.S. application Ser. No. 11/945,732, which has been incorporated by reference.

Once playback is paused 135, the recorded voice segment (of speech 140) can be audibly presented 136 to the user 122. The user 122 can then engages in conversation 146, during which time the audio device 120 can remain in a paused state. When the friend leaves 148 or the conversation 146 otherwise terminates, the paused playback can be resumed from the paused position 138. The resuming of payback can require a manual indication from user 122 or can occur automatically based upon an automatic detection of the conversion 146 ending.

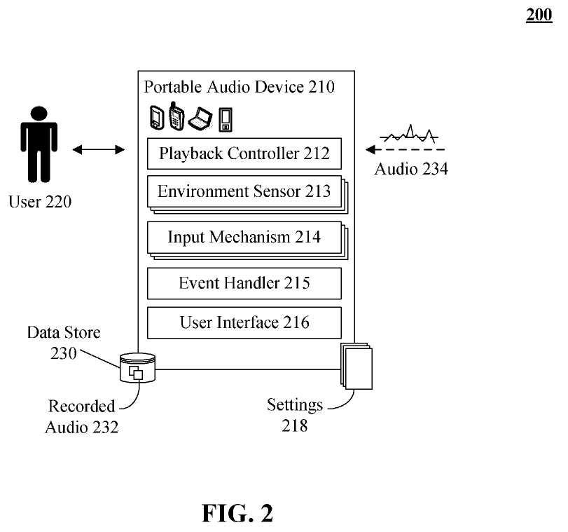

FIG. 2 is a schematic diagram illustrating a system 200 for automatic playback of a speech segment for media devices capable of pausing a media stream in accordance with an embodiment of the inventive arrangements disclosed herein. In system 200, a user 220 interacting with a portable audio device 210 can utilize a detected speech playback functionality to participate in an initiated conversation. Incoming audio 234 can be detected by sensor 213 which can trigger device 210 to record audio 234. Recorded audio 234 can be processed and stored in data store 230 as recorded audio 232. Stored audio 232 can be automatically presented to user 220 in response to a pausing event. A pausing event can include a proximate detected voice, a user pausing action (via input mechanism 214), and the like.

As used herein, audio device 210 can include, but is not limited to, audio/video device, mobile phone, portable media player, personal digital assistant (PDA), and the like. Device 210 can include input mechanism 214 able to receive input from user 220. Input mechanism can respond to user voice, user gestures, user selections via an attached peripheral, and the like. Mechanism 214 can include, but is not limited to, a microphone, a headset, an accelerometer, and the like. For example, a user 220 can pause playback of a media stream by nodding their head.

During playback operation, playback controller 212 can present a media stream to user 220. If device 210 detects proximate incoming audio 234, event handler 215 can begin to record audio 234. Detection of audio 234 can be configured based on a variety of settings 218 which can include, but is not limited to, proximity, loudness, direction, and the like. For example, speech above 40 decibels can be configured to trigger device 210 to commence recording. Handler 215 can utilize sensor 213 to record a detected proximate voice. In situations where multiple voices are detected, audio 234 can be stored in data store 230 where an analysis can be performed. Analysis of stored audio 232 can identify relevant speech segments proximate to user 220. Each speech segment can be ranked in order of relevancy based on one or more criteria determined through settings 218. The most relevant speech segment can be selected to be presented to user 220. Other digital signal processing (DSP) operations can be performed to ensure the user 220 can clearly hear desired speech contained within the recorded audio 232. Alternatively, the recorded speech 232 can be audibly presented to user 220 in an unprocessed manner.

Based on settings 218, voice detection can trigger a pausing event in device 210. A pausing event can activate controller 212 to automatically pause playback. If device 210 is configured to prompt the user 220 in response to a pausing event, interface 216 can be utilized to present user 220 with pausing options. When a user 220 chooses to ignore pausing event, playback controller 212 can continue to operate without interruption. In the event playback is paused, audio 232 can be presented to the user 220.

Based on threshold values in settings 218, recorded audio 232 can be modified and presented to the user. For example, when a speech segment is detected to be below fifty decibels, the speech segment loudness can be amplified and presented to user 220. Further, settings 218 can allow playback of recorded speech segment based on time markers. For instance, a user can configure device 210 to playback the last five seconds of recorded audio.

Settings 218 can be configured via user interface 216 which can be a graphical user interface (GUI), voice user interface (VUI), and the like. Interface 216 can permit user 220 to configure playback control, speech detection, pausing event handling, and the like.

In one embodiment, environmental audio can be recorded and stored in data 230 using a loop buffer mechanism. The loop buffer can be proportional to the available storage space the media device is able to use. For instance, a device 210 with one gigabyte of memory can utilize fifty megabytes of storage space for storing incoming audio 234.

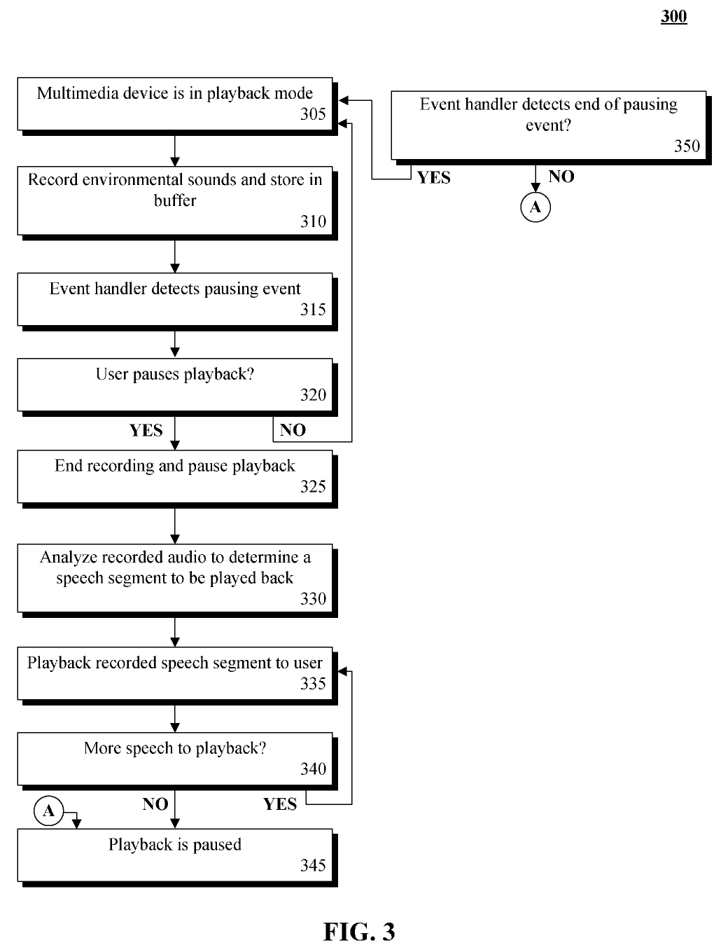

FIG. 3 is a flowchart illustrating a method 300 for automatic playback of a speech segment for media devices capable of pausing a media stream in accordance with an embodiment of the inventive arrangements disclosed herein. Method 300 can be performed in the context of system 200. In method 300, a multimedia device in playback mode can record detected speech segment from a proximate entity and playback the recorded speech segment to a user in response to a pausing event.

In step 305, a multimedia device in playback mode can present a media stream (e.g., audio) to a user. Multimedia device can include, but is not limited to, audio device, audio/video device, mobile phone, portable media player, personal digital assistant (PDA), and the like. In step 310, environmental sounds can be recorded and stored in a buffer. This buffer can be proportional to the available storage space the media device is able to use. In one embodiment, the media device can continuously record environmental audio on a loop buffer, until a pausing event is detected. In an alternative embodiment, environmental audio can be recorded in response to detected speech in proximity of the user.

In step 315, an event handler of the media player detects a pausing event has occurred. Pausing event can be automatically performed by the media device or manually triggered by a user. In step 320, if the user pauses playback of media stream, the method can continue to step 325, else return to step 305. In step 325, the media device can end recording and pause playback of media stream.

In step 330, recorded audio can be analyzed and a speech segment can be determined for playback. If more than one speech segment is determined, the most appropriate segment can be chosen based on proximity, loudness, direction, and the like. If the analysis fails to produce a speech segment, the user can be notified. In step 335, a determined speech segment can be presented to the user. In one embodiment, the presentation can be an audio playback on an output audio component such as a loudspeaker and/or headphone. In an alternative embodiment, speech to text can be performed and the speech segment can be presented as a textual message on the media device.

In step 340, if there are more speech segments to playback/present the method can return to step 335, else the method can continue to step 345. In step 345, playback remains paused until an end of pausing event is detected. In step 350, if the event handler detects an end of pausing event, the method can return step 305, else proceed to step 345.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for presenting a recorded speech segment on a multimedia device comprising:
playing audio using a multimedia device;
detecting speech in an environment proximate to a multimedia device;
recording the detected speech;
pausing the playing of the audio; and
audibly presenting the recorded speech.

2. The method of claim 1, further comprising:
detecting a condition to resume said paused audio; and
playing said paused audio from the previously paused position.

3. The method of claim 1, wherein said media device is a portable media device configured to record audio and configured to play digitally encoded music which is stored upon a medium accessible by the portable media device.

4. The method of claim 1, wherein said multimedia device is at least one of a portable digital music player and a mobile phone.

5. The method of claim 1, further comprising:
processing the recorded speech before audibly presenting the recorded speech using a digital signal processing algorithm executing upon the multimedia device, wherein the processing is configured to improve a clarity of the detected speech.

6. The method of claim 1, further comprising:
determining a sound pressure level of the detected speech; and
recording the detected speech only when the determined sound pressure level is above a previously designated threshold value.

7. The method of claim 1, further comprising:
presenting a notification of the detected speech via the multimedia device;
receiving a user input responsive to the notification; and
pausing the playing of the audio and audibly presenting the recorded speech only when the user input indicates that the user wishes the audio to be paused.

8. A computer program product for presenting a recorded speech segment on a multimedia device comprising:
a computer usable medium having computer usable program code embodied therewith, the computer usable program code comprising:
computer usable program code configured to play audio using a multimedia device;
computer usable program code configured to detect speech in an environment proximate to a multimedia device;
computer usable program code configured to record the detected speech;
computer usable program code configured to pause the playing of the audio; and
computer usable program code configured to audibly present the recorded speech.

9. The computer program product of claim 8, further comprising:
computer usable program code configured to detect a condition to resume said paused audio; and
computer usable program code configured to play said paused audio from the previously paused position.

10. The computer program product of claim 8, wherein said media device is a portable media device configured to record audio and configured to play digitally encoded music which is stored upon a medium accessible by the portable media device.

11. The computer program product of claim 8, wherein said multimedia device is at least one of a portable digital music player and a mobile phone.

12. The computer program product of claim 8, further comprising:
computer usable program code configured to process the recorded speech before audibly presenting the recorded speech using a digital signal processing algorithm executing upon the multimedia device, wherein the processing is configured to improve a clarity of the detected speech.

13. The computer program product of claim 8, further comprising:
computer usable program code configured to determine a sound pressure level of the detected speech; and
computer usable program code configured to record the detected speech only when the determined sound pressure level is above a previously designated threshold value.

14. The computer program product of claim 8, further comprising:
computer usable program code configured to present a notification of the detected speech via the multimedia device;
computer usable program code configured to receive a user input responsive to the notification; and
computer usable program code configured to pause the playing of the audio and audibly presenting the recorded speech only when the user input indicates that the user wishes the audio to be paused.

15. A multimedia device comprising:
an audio microphone configured to record audio;
a speaker configured to play audio;
a data store configured to store digitally encoded audio;
an environment sensor configured to selectively detect an occurrence of speech likely to be directed at a user of the multimedia device and to automatically record the detected speech in the data store; and
a playback controller configured to audibly present digitally encoded audio of the data store via the speaker, wherein the playback controller is configured to selectively pause a playback of a first audio file stored responsive to an occurrence of a pause event and to automatically audibly present the automatically recorded detected speech upon pausing the playback of the first audio file.

16. The device of claim 15, wherein said media device is a portable media device.

17. The device of claim 15, wherein said multimedia device is at least one of a portable digital music player and a mobile phone.

18. The device of claim 15, further comprising:
an alert mechanism configured to alert a user when the environment sensor detects the occurrence of speech likely to be directed at a user of the multimedia device;
an input mechanism configured to detect a gesture by the user which is indicative of a user decision on whether to pause the playback of the first audio file responsive to a detected speech occurrence, wherein activation of the playback controller function that pauses the playback of the first audio file is dependent upon the gesture detected by the input mechanism.
